(19) United States
(12) Patent Application Publication
(10) Pub. No.: US 2026/0077368 A1
(43) Pub. Date: Mar. 19, 2026

(54) METHODS AND APPARATUS FOR THERMAL SPRAYING OF COATINGS

(71) Applicant: PPG Industries Ohio, Inc., Cleveland, OH (US)

(72) Inventors: Kathrine Elizabeth Flood, Santa Cruz, CA (US); Brian Kirk Rearick, Jr., Allison Park, PA (US); DeAnna Dawn Katz, Gibsonia, PA (US); Brandon Glenn Petrouskie, Rochester, MI (US); Aaron Roger Zatorsky, Murrysville, PA (US); Heather Nedzesky Santo, Pittsburgh, PA (US); Anthony M. Chasser, Greensburgh, PA (US); Alexander Paul Adams, Allison Park, PA (US); Vincent Salvatore Pagnotti, Wexford, PA (US); Daniel K. Dei, Pittsburgh, PA (US); Michael Andrew Zalich, Wexford, PA (US); Pedro Velez-Herrera, Pittsburgh, PA (US); Brian Edward Woodworth, Glenshaw, PA (US); Troy James Larimer, North Huntingdon, PA (US); Mark P. Bowman, New Kensington, PA (US)

(73) Assignee: PPG Industries Ohio, Inc., Cleveland, OH (US)

(21) Appl. No.: 19/106,665

(22) PCT Filed: Jun. 28, 2023
(86) PCT No.: PCT/US2023/069256

§ 371 Date: Feb. 26, 2025

Related U.S. Application Data
(60) Provisional application No. 63/374,411, filed on Sep. 2, 2022.

(51) Int. Cl. B05B 7/20; B05B 12/16; B05D 1/10; B05D 3/02

(52) U.S. Cl. CPC B05B 7/205; B05B 12/16; B05D 1/10; B05D 3/0227; B05D 3/0263

(57) ABSTRACT

Methods of thermal spraying polymeric coatings are disclosed. A powder polymeric coating material is introduced into a thermal spray applicator. Particles of the polymeric coating material are heated by the thermal spray applicator, and the heated coating particles are directed toward a substrate to form a deposited coating. The deposited coating may be post-heated onto the substrate to form the polymeric coating with desirable surface characteristics. Thermal spray coating systems are also disclosed for thermally spraying the polymeric coatings. The thermal spray applicator may include a combustion chamber and an injection nozzle assembly that transfers coating powders to a heated zone generated from the combustion chamber.

### CROSS-REFERENCE TO RELATED APPLICATION

This application claims the benefit of U.S. Provisional Patent Application No. 63/374,411 filed Sep. 2, 2022, which is incorporated herein by reference.

### GOVERNMENT CONTRACT

This disclosure was made with Government support under Government Contract No. NCMS 201660 awarded by the United States Army Ground Vehicle Systems Center. The United States Government has certain rights in this disclosure.

### FIELD

Methods and apparatus for thermal spraying of coatings are disclosed.

### BACKGROUND

Electrostatic coatings are conventionally produced by depositing solid coating powders onto electrically charged substrates and heating to melt and fuse the particles together to form a coating film. The coatings are applied in a controlled environment such as a temperature-, pressure- and humidity-controlled application booth.

### SUMMARY

Disclosed herein is a method of thermal spraying a polymeric coating comprising heating particles of a powder polymeric coating material with a thermal spray applicator and directing the heated coating particles toward a substrate, depositing the heated coating particles on the substrate to form a deposited coating, and post-heating the deposited coating on the substrate to form the polymeric coating.

Disclosed herein is a thermal spray applicator for thermal spraying of coatings comprising a combustion chamber including a combustion zone structured and arranged to receive a fuel/air mixture, and an injection nozzle assembly structured and arranged to receive heat flow from the combustion chamber, the injection nozzle assembly comprising a coating powder injector nozzle including a coating powder nozzle inlet adjacent a base of the coating powder injector nozzle, and a coating powder nozzle outlet at a nozzle front opening of the coating powder injector nozzle, and an air shroud at least partially surrounding the coating powder injector nozzle defining a shroud air flow region between the coating powder injector nozzle and the air shroud, wherein the coating powder injector nozzle is structured and arranged to produce a non-circular or non-uniform spray coating pattern when the coating powder passes through the coating powder nozzle outlet and is subjected to shroud air flowing out from the shroud air flow region and the heat flow from the combustion chamber.

### BRIEF DESCRIPTION OF THE DRAWINGS

FIG. 1 schematically illustrates a system for thermal spraying of coatings.

FIG. 2 schematically illustrates a substrate with a coating produced by a thermal spray process.

FIG. 3 schematically illustrates features of a thermal spray applicator that may be used for thermal spraying of coatings.

FIG. 4 is a partially schematic side view of a powder injection nozzle for thermal spraying of coatings including a round outlet opening.

FIG. 5 is a partially schematic side view of a powder injection nozzle for thermal spraying of coatings including a elongated outlet opening.

FIG. 6 is a partially schematic side view of a powder injection nozzle for thermal spraying of coatings including a rectangular outlet opening.

FIG. 7 is a partially schematic side sectional view of a thermal spray applicator for thermal spraying of coatings.

FIG. 8 is a side view of a powder injection nozzle assembly of the thermal spray applicator of FIG. 7.

FIG. 9 is a top view of a powder injection nozzle assembly of the thermal spray applicator of FIG. 7.

FIG. 10 is a front view of a powder injection nozzle assembly of the thermal spray applicator of FIG. 7.

FIG. 11 is a front view of a shield or air shroud of the powder injection nozzle assembly of FIGS. 8-10.

FIG. 12 is a partially schematic side view of a powder injection nozzle assembly of a thermal spray applicator including a flow diverter.

FIG. 13 is a partially schematic side view of a powder injection nozzle assembly of a thermal spray applicator including a flow diverter.

FIG. 14 is a partially schematic side view of a powder injection nozzle assembly of a thermal spray applicator including a flow diverter.

FIG. 15 is a partially schematic side view of a powder injection nozzle assembly and an illustration of a spray pattern generated by the nozzle assembly.

FIG. 16 is a partially schematic side view of a powder injection nozzle assembly and an illustration of a spray pattern generated by the nozzle assembly.

FIG. 17 is a partially schematic side view of a powder injection nozzle assembly and an illustration of a spray pattern generated by the nozzle assembly.

FIG. 18 is a roughness chart for thermally sprayed thermoset coatings subjected to different application parameters during the thermal spraying process.

FIG. 19 is a roughness chart for thermally sprayed thermoplastic coatings subjected to different application parameters during the thermal spraying process.

FIG. 20 are roughness charts for thermally sprayed thermoset and thermoplastic coatings subjected to different application parameters during the thermal spraying process.

FIG. 21 are roughness charts for thermally sprayed thermoset and thermoplastic coatings subjected to different application parameters during the thermal spraying process.

FIG. 22 is a three-dimensional surface image of a thermally sprayed coating showing relatively low surface roughness.

FIG. 23 is a three-dimensional surface image of a thermally sprayed coating showing relatively high surface roughness.

FIG. 24 is a three-dimensional surface image of a thermally sprayed coating showing relatively low surface roughness.

FIG. 25 is a three-dimensional surface image of a thermally sprayed coating showing relatively high surface roughness.

FIG. 26 are magnified images corresponding to the low surface roughnesses and high surface roughnesses shown in FIGS. 22-25.

### DETAILED DESCRIPTION

Thermal spray application of powder coatings at selected powder film builds is provided, including crosslinkable thermoset and thermoplastic powders. Commercially manufactured powder paint normally applied by electrostatic coating techniques may be applied at desired film thicknesses and with favorable final properties such as color, gloss, adhesion, hardness and distinctness of image, with a high degree of reproducibility. The thermal spray coating systems are capable of producing coatings from starting powders in field settings rather than being restricted to more controlled manufacturing settings. The method does not require electrostatics or a pressure and humidity-controlled application booth, making field applications possible.

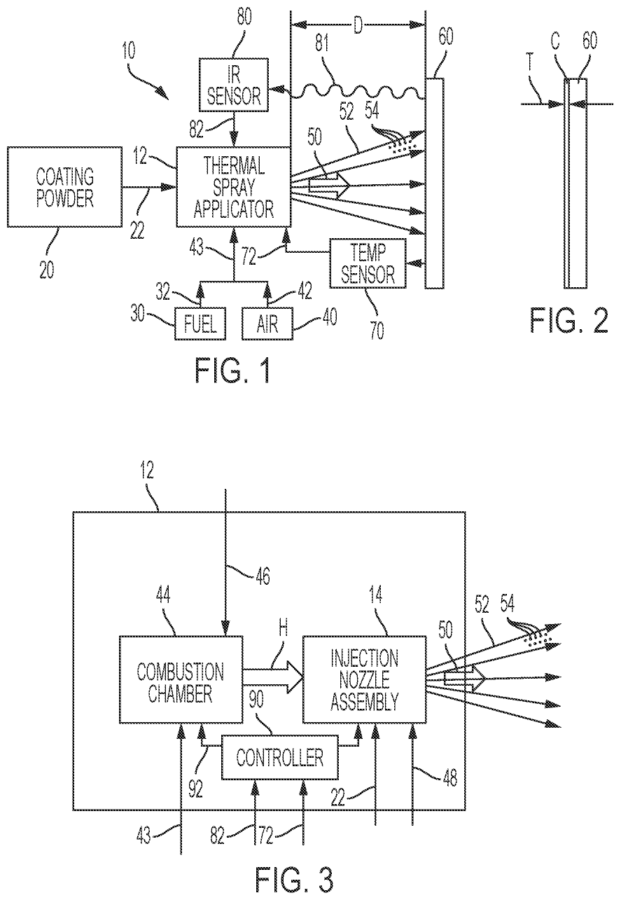

FIG. 1 schematically illustrates a thermal spray coating system. The thermal spray coating system 10 includes a thermal spray applicator 12 with a supply of coating powder 20 that is fed to the applicator by a coating powder supply line 22. Fuel 30 such as propane or the like may be fed to the thermal spray applicator 12 via a fuel supply line 32. Combustion air 40 is fed to the thermal spray applicator 12 via an air supply line 42. As shown in FIG. 1, the fuel supply 32 line and combustion air supply 42 line may be combined into a fuel/air mixture supply 43 for combustion in the thermal spray applicator 12. Alternatively, the combustion air may be supplied separately from the fuel into the combustion zone.

During operation, the thermal spray applicator 12 generates a heated gas stream 50 that is directed toward a substrate 60. The outlet end of the thermal spray applicator 12 is located a spray distance D from the surface of the substrate 60. The coating powder 20 fed into the thermal spray applicator 12 is heated in flight by the heated gas stream 50. The heated coating powder is projected in a spray pattern 52 of heated coating particles 54 toward the substrate 60. During flight, the solid particles of the coating powder 20 are heated and at least partially melted by the heated gas stream 50 to form the heated coating particles. A thermally sprayed coating C is formed on the surface of the substrate 60, as shown in FIG. 2.

Any suitable type of substrate 60 may be at least partially coated by the spray applicator 12, including metal, cement, brick, tile, stone, porcelain, ceramic, glass, wood and wood composites, fiberboards, plastics and polymer-based substrates, carbon fiber substrates and the like.

As used herein, when referring to the heated coating particles 54, the terms “melt”, “melted” and “molten” include full or partial transformation of the solid particles of the coating powder 20 into a liquid or softened solid form. Upon impact with the substrate 60, or with previously deposited coating particles, the heated coating particles 54 adhere to the substrate 60 and/or the previously deposited layers of the coating material. As more fully described below, the deposited coating material may be subjected to a post-heat process to reduce roughness and provide a smooth surface. e.g., by further melting or flowing of the heated coating particles after their initial deposition on the substrate 60. Post-heating may also be used to cure or crosslink thermoset powder coatings.

As further shown in FIG. 1, a temperature sensor 70 may be provided on or near the substrate 60 to measure the temperature of the substrate 60 and/or heated coating spray 52 during operation. The temperature sensor 70 may send a temperature signal 72 to the thermal spray applicator 12, as more fully described below.

The thermal spray coating system 10 of FIG. 1 may also include an infrared sensor 80 that detects infrared radiation 81 generated from the substrate 60 and/or thermal spray 52. An IR signal 82 may be fed from the IR sensor 80 to the thermal spray applicator 12. The IR sensor 80 may optionally include, or be replaced by, an IR heater that may be used to pre-heat and/or post-heat the substrate 60, as more fully described below. The IR heater may be provided separately from the thermal spray applicator 12 or may be provided as a component of the thermal spray applicator 12. Such an IR heater may supplement the heat provided by the heated gas stream 50 of the thermal spray applicator 12 during operation or may serve as the sole heat source during pre-heating and/or post-heating.

FIG. 3 schematically illustrates features of the thermal spray applicator 12. A combustion chamber 44 receives the fuel/air mixture 43 and generates a heat flow H upon combustion of the fuel. An injection nozzle assembly 14 fed by the coating powder supply line 22 is located in a thermal zone in or adjacent to the combustion chamber 44. The coating powder injected into the thermal zone is then projected from the thermal spray applicator 12 via the heated gas stream 50 to form the coating spray pattern 52 of heated coating particles 54.

A controller 90 may communicate via a control signal 92 with components that adjust parameters such as the fuel/air mixture supplied to the combustion chamber 44 and via another control signal 94 to the injection nozzle assembly 14 during operation. The controller 90 may receive the temperature sensor signal 72 and the IR sensor signal 82 and may also control operation of any IR heater.

As shown in FIG. 3, ambient cooling air 46 from the atmosphere may be drawn into the combustion chamber 44 of the thermal spray applicator 12 in order to protect the equipment from overheating and/or control the flow pattern of combustion gas. The cooling gas 46 may be at atmospheric pressure or may be pressurized. As further shown in FIG. 3, cooling gas may be fed through a shroud air supply line 48 to the injection nozzle assembly 14, as more fully described below. As more fully described below, the thermal spray applicator 12 may be a commercially available unit that is adapted to apply the thermal spray coatings, such as a thermal powder applicator sold under the designation of PTS-30 by Resodyn Engineered Polymeric Systems and embodied in U.S. Pat. No. 9,095,863, which is incorporated herein by reference.

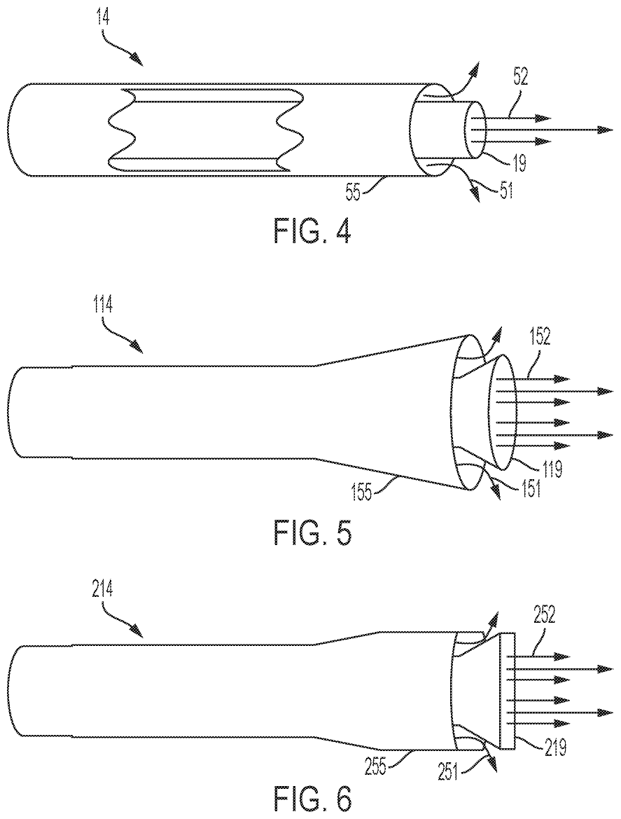

FIGS. 4-6 schematically illustrate injection nozzle assemblies. In FIG. 4, an injection nozzle assembly 14 includes a nozzle front opening 19. An air shroud 55 surrounds the nozzle front opening 19 and provides a shroud air outlet flow 51 forming a spray pattern 52.

As shown in FIG. 5, an injection nozzle assembly 114 includes a nozzle front opening 119. An air shroud 155 surrounds the nozzle front opening 119 and provides a shroud air outlet flow 151 forming a spray pattern 152.

In FIG. 6, an injection nozzle assembly 214 includes a nozzle front opening 219. An air shroud 255 surrounds the nozzle front opening 219 and provides a shroud air outlet flow 251 forming a spray pattern 252.

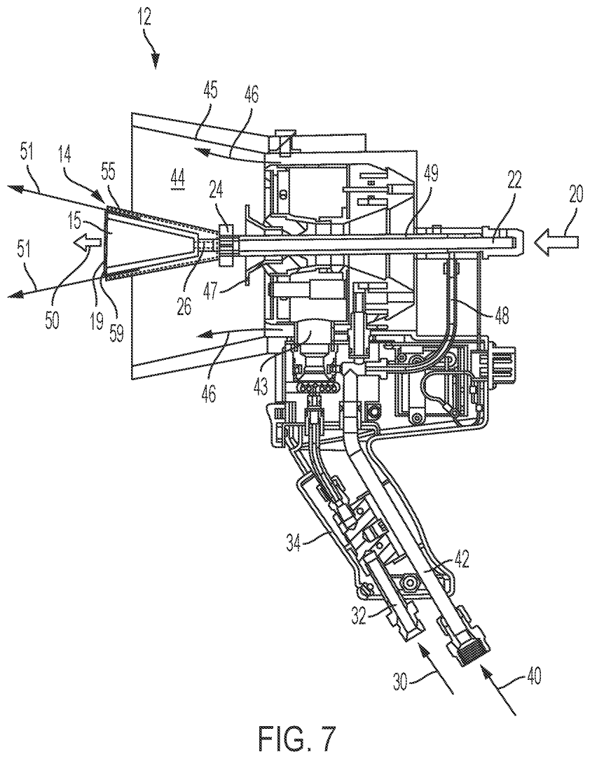

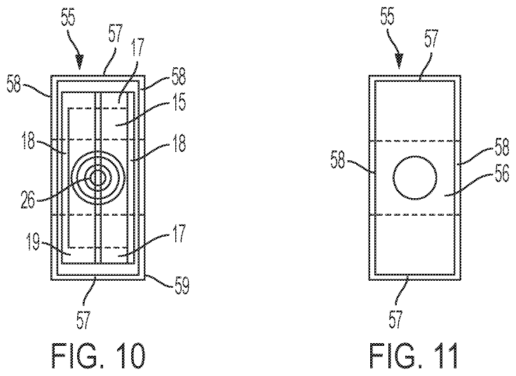

FIGS. 7-11 illustrate features of a thermal spray coating applicator 12. The thermal spray coating applicator 12 includes an injection nozzle assembly 14 comprising a powder injector nozzle 15. The powder injector nozzle 15 includes a base 16, opposing upper and lower walls 17, opposing sidewalls 18, and nozzle front opening 19.

The coating powder supply 20 feeds into the coating powder supply line 22, which extends through the applicator to a nozzle fitting 24 connected to a nozzle inlet 26 of the powder injector nozzle 15. The coating powder may optionally be entrained in a carrier gas such as air, and the combined carrier gas and coating powder may be delivered through the powder supply line 22. The pressure and/or flow rate of the corner gas and coating powder may be controlled in order to adjust the velocity of the coating particles delivered through the thermal spray applicator 12.

As shown in FIG. 7, the fuel supply 30 is fed to the fuel supply line 32, which is selectively opened and closed with a fuel supply trigger 34. The pressurized combustion air supply 40 is fed to the combustion air supply line 42. Fuel from the fuel supply line 32 and combustion air from the combustion air supply line 42 are mixed together in a combined fuel/air mixture zone 43. The fuel/air mixture is then combusted in a combustion zone of the combustion chamber 44 within a heat shield 45 of the applicator 12. Ambient cooling air 46 may be drawn or forced under pressure into the combustion zone of the combustion chamber 44. A conical collar 47 is provided adjacent to the end of the coating powder supply line 22 inside the heat shield 45. The collar 47 may direct air from the back of the gun to the combustion zone of the combustion chamber 44 to increase the burning efficiency of the fuel 30 and to help contain the flame in the shroud.

As further shown in FIG. 7, the shroud air supply line 48 communicates by a valve with the combustion air supply line 42 to direct a portion of the pressurized air through a shroud air feed line 49 that surrounds the coating powder supply line 22 and exits into an air shroud 55.

The air shroud 55 includes a base 56, opposing upper and lower walls 57, opposing sidewalls 58, and a front edge 59. The air shroud 55 creates a shroud air outlet flow 51 that feeds into the heated gas stream 50. The outlet air flow 51 may help to shape the spray pattern 52 and may also help to control the velocity of the heated coating particles 54 as they travel toward the substrate 60.

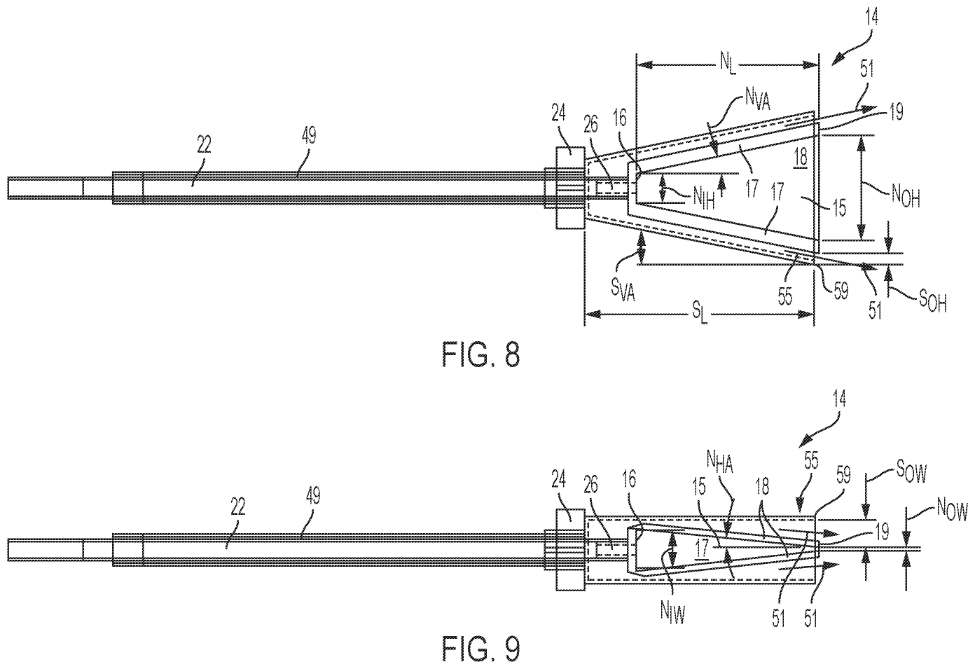

As shown in detail in FIGS. 8-11, the powder injector nozzle 15 has a nozzle length N_{L}, a nozzle outlet height N_{OH}, a nozzle outlet width N_{OW}, a nozzle inlet height N_{IH}, a nozzle inlet width N_{IW}, a nozzle vertical taper angle N_{VA}, and a nozzle horizontal taper angle N_{HA}. As further shown in FIGS. 8-11, the air shroud 55 has an air shroud length S_{L}, an air shroud outlet opening height S_{OH}, an air shroud outlet opening width S_{OW}, and an air shroud vertical taper angle S_{VA}.

The nozzle outlet length N_{L} is typically at least 0.3 inch, for example, at least 1 inch, or at least 2 inches, or at least 2.5 inches. The nozzle outlet length N_{L} is typically less than 30 inches, for example, less than 10 inches, or less than 6 inches, or less than 4 inches. The nozzle outlet length N_{L} may typically range from 0.3 to 30 inches, or from 1 to 10 inches, or from 2 to 6 inches, or from 2.5 to 4 inches.

The nozzle outlet height N_{OH} is typically at least 0.15 inch, for example, at least 0.3 inch, or at least 0.5 inch, or at least 1 inch. The nozzle outlet height N_{OH} is typically less than 15 inches, for example, less than 6 inches, or less than 4 inches, or less than 2 inches. The nozzle outlet height N_{OH} may typically range from 0.15 to 15 inches, or from 0.3 to 6 inches, or from 0.5 to 4 inches, or from 1 to 2 inches.

The nozzle outlet width N_{OW} is typically at least 0.01 inch, for example, at least 0.02 inch, or at least 0.03 inch, or at least 0.05 inch. The nozzle outlet width N_{OW} is typically less than 10 inches, for example, less than 5 inches, or less than 0.5 inch, or less than 0.2 inch. The nozzle outlet width N_{OW} may typically range from 0.01 to 10 inches, or from 0.02 to 5 inches, or from 0.03 to 0.5 inch, or from 0.05 to 0.2 inch.

The ratio of the nozzle outlet height to the nozzle outlet width, N_{OH}:N_{OW}, is typically at least 1.1:1, for example, at least 2:1, or at least 4:1, or at least 10:1. The ratio of the nozzle outlet height to the nozzle outlet width, N_{OH}:N_{OW}, is typically less than 150:1, for example, less than 50:1, or less than 30:1, or less than 20:1. The ratio of the nozzle outlet height to the nozzle outlet width, N_{OH}:N_{OW}, may typically range from 1.1:1 to 150:1, or from 2:1 to 50:1, or from 4:1 to 30:1, or from 10:1 to 20:1.

The nozzle inlet height N_{IH} is typically at least 0.05 inch, for example, at least 0.1 inch, or at least 0.15 inch, or at least 0.2 inch. The nozzle inlet height N_{IH} is typically less than 5 inches, for example, less than 2 inches, or less than 1 inch, or less than 0.6 inch. The nozzle inlet height N_{IH} may typically range from 0.05 to 5 inches, or from 0.1 to 2 inches, or from 0.15 to 1 inch, or from 0.2 to 0.6 inch.

The ratio of the nozzle outlet height to the nozzle inlet height, N_{OH}:N_{IH}, is typically at least 0.5:1, for example, at least 1:1, or at least 2:1, or at least 3:1. The ratio of the nozzle outlet height to the nozzle inlet height, N_{OH}:N_{IH}, is typically less than 40:1, for example, less than 20:1, or less than 10:1, or less than 5:1. The ratio of the nozzle outlet height to the nozzle inlet height, N_{OH}:N_{IH}, may typically range from 0.5:1 to 40:1, or from 1:1 to 20:1, or from 2:1 to 10:1, or from 3:1 to 5:1.

The nozzle inlet width N_{IW} is typically at least 0.5 inch, for example, at least 0.1 inch, or at least 0.2 inch, or at least 0.4 inch. The nozzle inlet width N_{IW} is typically less than 5 inches, for example, less than 2 inches, or less than 1 inch, or less than 0.8 inch. The nozzle inlet width N_{IW} may typically range from 0.05 to 5 inches, or from 0.1 to 2 inches, or from 0.2 to 1 inch, or from 0.4 to 0.8 inch.

The ratio of the nozzle inlet height to the nozzle inlet width, N_{IH}:N_{IW}, is typically at least 0.05:1, for example, at least 0.1:1, or at least 0.3:1, or at least 0.5:1. The ratio of the nozzle inlet height to the nozzle inlet width, N_{IH}:N_{IW}, is typically less than 10:1, for example, less than 5:1, or less than 2:1, or less than 1:1. The ratio of the nozzle inlet height to the nozzle inlet width, N_{IH}:N_{IW}, may typically range from 0.05:1 to 10:1, or from 0.1:1 to 5:1, or from 0.3:1 to 2:1, or from 0.5:1 to 1:1.

The nozzle vertical taper angle N_{VA} is typically at least 1°, for example, at least 2°, or at least 5°, or at least 8°. The nozzle vertical taper angle N_{VA} is typically less than 60°, for example, less than 40°, or less than 20°, or less than 12°. The nozzle vertical taper angle N_{VA} may typically range from 1 to 60°, or from 2 to 40°, or from 5 to 20°, or from 8 to 12°.

The nozzle horizontal taper angle N_{HA} is typically at least 0.5°, for example, at least 1°, or at least 2°, or at least 4°. The nozzle horizontal taper angle N_{HA} is typically less than 40°, for example, less than 20°, or less than 12°, or less than 8°. The nozzle horizontal taper angle N_{HA} may typically range from 0.5 to 40°, or from 1 to 20°, or from 2 to 12°, or from 4 to 8°.

The ratio of the nozzle vertical taper angle to the nozzle horizontal taper angle, N_{VA}:N_{HA}, is typically at least 0.2:1, for example, at least 0.5:1, or at least 1:1, or at least 1.5:1. The ratio of the nozzle vertical taper angle to the nozzle horizontal taper angle, N_{VA}:N_{HA}, is typically less than 15:1, for example, less than 10:1, or less than 5:1, or less than 2:1. The ratio of the nozzle vertical taper angle to the nozzle horizontal taper angle, N_{VA}:N_{HA}, may typically range from 0.2:1 to 15:1, or from 0.5:1 to 10:1, or from 1:1 to 5:1, or from 1.5:1 to 2:1.

The air shroud length S_{L} is typically at least 0.3 inch, for example, at least 0.5 inch, or at least 1 inch, or at least 2 inches. The air shroud length S_{L} is typically less than 30 inches, for example, less than 15 inches, or less than 10 inches, or less than 6 inches. The air shroud length S_{L} may typically range from 0.3 to 30 inches, or from 0.5 to 15 inches, or from 1 to 10 inches, or from 2 to 6 inches.

The air shroud outlet opening height S_{OH} is typically at least 0.01 inch, for example, at least 0.03 inch, or at least 0.05 inch, or at least 0.08 inch. The air shroud outlet opening height S_{OH} is typically less than 1 inch, for example, less than 0.5 inch, or less than 0.3 inch, or less than 0.2 inch. The air shroud outlet opening height S_{OH} may typically range from 0.01 to 1 inch, or from 0.03 to 0.5 inch, or from 0.05 to 0.3 inch, or from 0.08 to 0.2 inch.

The air shroud outlet opening width S_{OW} is typically at least 0.05 inch, for example, at least 0.1 inch, or at least 0.2 inch, or at least 0.3 inch. The air shroud outlet opening width S_{OW} is typically less than 5 inches, for example, less than 2 inches, or less than 1 inch, or less than 0.5 inch. The air shroud outlet opening width S_{OW} may typically range from 0.05 to 5 inches, or from 0.1 to 2 inches, or from 0.2 to 1 inch, or from 0.3 to 0.5 inch.

The ratio of the air shroud outlet opening height to the air shroud outlet opening width, S_{OH}:S_{OW}, is typically at least 0.3:1, for example, at least 0.5:1, or at least 1:1, or at least 2:1. The ratio of the air shroud outlet opening height to the air shroud outlet opening width, S_{OH}:S_{OW}, is typically less than 30:1, for example, less than 15:1, or less than 8:1, or less than 4:1. The ratio of the air shroud outlet opening height to the air shroud outlet opening width, S_{OH}:S_{OW}, may typically range from 0.3:1 to 30:1, or from 0.5:1 to 15:1, or from 1:1 to 8:1, or from 2:1 to 4:1.

The air shroud vertical taper angle S_{VA} is typically at least 1°, for example, at least 2°, or at least 5°, or at least 8°. The air shroud vertical taper angle S_{VA} is typically less than 60°, for example, less than 40°, or less than 20°, or less than 12°. The air shroud vertical taper angle S_{VA} may typically range from 1 to 60°, or from 2 to 40°, or from 5 to 20°, or from 8 to 12°. The air shroud vertical taper angle S_{VA} and the nozzle vertical taper angle N_{VA} may be the same or may be different from each other.

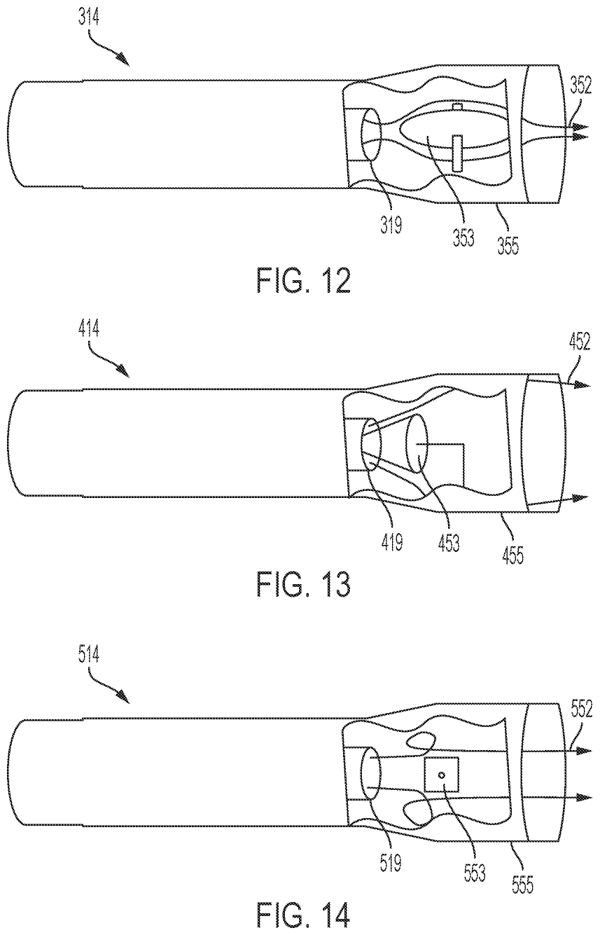

The applicator head may also include a flow diverter at least partially in front of or within the spray nozzle tube. Examples of flow diverters are schematically shown in FIGS. 12-14. As used herein, the term “flow diverter” is defined as a flow splitter, obstacle, vane, vortex generator or similar implement used to direct, redirect, broaden, narrow, or disrupt the flow of gas, powder or both and/or to break up particle/powder agglomerations and/or to provide desired turbulent or laminar flow or aerodynamics. The flow diverter may be constructed in a shape so designed to achieve the desired flow modification and may be located at least partially in the flow path of the gas/powder moving through or exiting the nozzle. The flow diverter may be placed anywhere along the powder/gas flow path from the exit of the venture pump at the beginning of the powder supply tube to a distance up to and including 6 inches beyond the spray nozzle exit orifice.

FIG. 12 schematically illustrates an injection nozzle assembly 314 including a nozzle front opening 319, air shroud 355, and an oval-shaped flow diverter 353 that acts as an obstruction to the flow path of the spray pattern 352.

FIG. 13 schematically illustrates an injection nozzle assembly 414 including a conical flow diverter 453 with a base diameter approximately 1.2 times the diameter of a spray nozzle front opening 419. The outer diameter of the flow diverter 453 narrows to a fine apex with a cone height equal to its radius (½ base). The flow diverter 453 is located in an air shroud 455 in front of the nozzle front opening 419 with the apex deposited in the center of the nozzle protruding into the nozzle to a distance of 1/50 of the conc height. The flow diverter 453 is designed to have the effect of broadening the flow path 452 out of the nozzle radially and to disrupt and distribute the powder exiting the nozzle in a like manner to provide a conical spray pattern.

FIG. 14 schematically illustrates an injection nozzle assembly 514 including a nozzle front opening 519, air shroud 555, and a square flow diverter 553 that acts as an obstruction to the flow path of the spray pattern 552.

One skilled in the art would understand that numerous other flow diverter designs and dimensions could be used to provide desired flow characteristics.

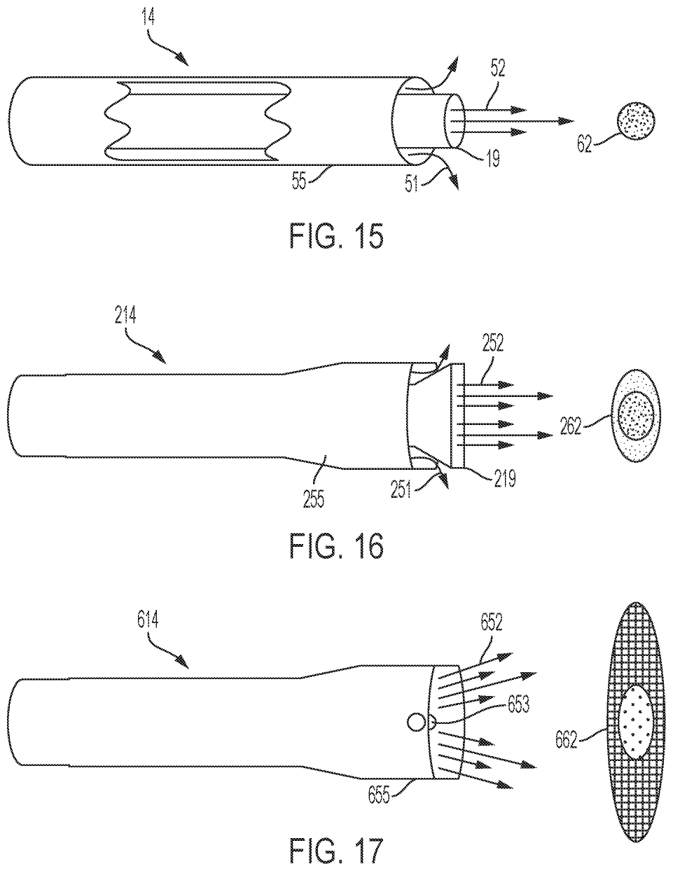

FIGS. 15-17 schematically illustrate examples of powder injection nozzle assemblies and spray patterns generated by the nozzle assemblies. In FIG. 15, a uniform round deposited coating pattern 62 formed by the injection nozzle assembly 14 illustrated in FIG. 4.

FIG. 16 illustrates a non-uniform elongated deposited coating pattern 262 produced by the injection nozzle assembly 214 illustrated in FIG. 6. More coating material is deposited at the center of the spray pattern than at its perimeter.

FIG. 17 illustrates a deposited coating pattern 662 produced by an injection nozzle assembly 614 having a flow divert 653 inside an air shroud 655. The flow diverter 653 acts as an obstruction to the spray pattern 662, which forms the deposited coating pattern 662 having less coating material deposited at the center of the deposited coating pattern 662 and more coating material deposited around its perimeter.

The thermal spray applicator 12 may be used to apply coating compositions without overspray to produce a desired pattern and/or design over the substrate 60. As a nonlimiting example, the thermal spray applicator 12 may apply coating compositions in a single pass without masking the substrate 60 to produce two or more colors over different portions of the substrate 60 and/or produce a desired pattern and/or design over the substrate 60. The thermal spray coating system 10 may use a single thermal spray applicator 12 and/or multiple thermal spray applicators 12. Coating operations may include multiple passes, which may be overlapping or non-overlapping. When overlapping passes are used, any suitable amount of overlap may be employed, for example, from 5 or 10 percent up to 20, 30, 40 or 50 percent, or more. During each pass, the path widths of the spray patterns 52 may be controlled as desired. Edge sharpness of each pass may be controlled, as well as providing desired transfer efficiencies using the thermal spray applicator 12. Precision coatings may be applied, for example, to specifically selected portion(s) of a substrate when initially coating a substrate or when making field repairs to the substrate.

The present thermal spray systems may be used to produce thermoset coatings and/or thermoplastic coatings. Examples of powders that may be used to produce thermoset coatings include epoxy/phenolic, polyester TGIC, polyester Hydroxyalkyl amide, GMA acrylics and blends thereof. As used herein, the term “thermoset powder” includes powders that form thermoset coatings upon heating and cross-linking to form thermoset polymers. Examples of thermoset polymer coatings that may be produced from the thermoset powders include epoxy, polyester, acrylic and vinyl ether polymers and the like. Suitable thermoset epoxy polymers include Epon1001, Epon 2002, Epon 2004 and Epon 1007F. Suitable polyester polymers include Uralac P800, Uralac P1580, Crylcoat 1581-6, Crylcoat 1701-0. Suitable acrylic polymers include Almatex PD7610, GMA 300 from Estron, Almatex PD6300 and Almatex PD1700. Further examples of thermoset polymer coatings include BPA epoxy, non-BPA epoxy, polyamide, polyurethane, polyurea, polyimide, fluoropolymer, polysiloxane, polysulfone, polysulfide, polyolefin, polyether, polyketone, (organo) silicone and novalac phenolic. Suitable vinyl ether polymers include Uralac P1900C, Uralac P1910C and Uralac P1920C.

Examples of powders that may be used to produce thermoplastic polymer coatings include fluoropolymers such as polyvinylidene fluoride (PVDF), polytetrafluoroethylene (PTFE), FEVE and polyvinyl fluoride (PVF), polyethylene copolymers such as functional group grafted polyolefins, polyamide, polysiloxane, polyketone, polyurethane, polyurea, polysulfone vinyl acetate polymers, acrylic/vinyl acetate copolymers, and other thermoplastics such as nylon, polyester, polyvinyl chloride (PVC), acrylics, vinyl acetates and blends thereof.

The average particle size of the starting powders may typically be from 5 to 150 microns, for example, from 10 to 100 microns, or from 20 to 50 microns, or from 35 to 40 microns. In some cases, the average particle size may range from 5 to 50 microns, or from 30 to 40 microns. The average particle size may be less than 100 microns, or less than 60 microns, or less than 50 microns, or less than 40 microns, or less than 30 microns, or less than 25 microns. For thermoset powders, the average particle size may typically be from 5 to 150 microns, for example, from 10 to 100 microns, or from 20 to 50 microns. For thermoplastic powders, the average particle size may typically be from 1 to 1,000 microns, for example, from 5 to 500 microns, or from 10 to 200 microns. The average particle size may be measured by the standard laser diffraction test for measuring particle size distribution with a Beckmann-Coulter LS 12 320 Laser Diffraction Particle Size Analyzer.

The particles of the coating powder may have substantially equiaxed or spherical shapes, for example, with aspect ratios of less than 2:1, or less than 1.5:1, or less than 1.2:1, or about 1:1, as measured by standard SEM techniques.

The starting powders used in the thermal spray process, such as the thermosets and thermoplastics described above, may have typical glass transition temperatures T_{g} of from 30 to 120° C., for example, from 40 to 110° C., or from 50 to 100° C. The glass transition temperatures may be less than 120° C., or less than 100° C., or less than 80° C., or less than 60° C. The glass transition temperature T_{g} may be measured by the standard ASTM D3418-12 technique.

The starting powders may have typical average molecular weights of from 1,000 to 200,000, for example, from 5,000 to 100,000, or from 8,000 to 50,000, or from 10,000 to 40,000. Certain polymers may have average molecular weights of 30,000 or less, for example, 25,000 or less, or 20,000 or less. The average molecular weight is measured by the standard Gel permeation chromatography ASTM D6579-11 test.

Typical substrate pre-heat temperatures T_{P} may typically range from 100 to 300° C., for example, from 120 to 250° C., or from 150 to 220° C., or from 170 to 200° C. Minimum pre-heat temperatures may be at least 80° C., or at least 100° C., or at least 120° C., or at least 150° C. The substrate 60 may be pre-heated by the thermal spray applicator 12. Alternatively, pre-heating may be achieved with an IR heater that is part of the spray applicator 12, or that is provided as a separate component, e.g., as part of the IR sensor 80.

During flight, the heated coating particles 52 may reach typical temperatures of up to 350° C., for example, up to 300° C., or up to 250° C. or up to 200° C. The in-flight temperatures may be at least 50° C. or at least 100° C. or at least 150° C. The in-flight temperature may be controlled based upon the composition of the coating powders being sprayed, e.g., to ensure that the thermoset or thermoplastic powders do not burn or otherwise become degraded.

The pre-heat temperatures and/or in-flight temperatures may be selected based upon the glass transition temperature T_{g} of the powder being sprayed. For example, the pre-heat temperature T_{P} may be within the range T_{P}=T_{g}±50° C., or ±100° C., or ±125° C.

Typical substrate post-heat temperatures T_{H} typically range from 50 to 350° C., for example, from 100 to 300° C., or from 150 to 280° C., or from 180 to 260° C., or from 200 to 240° C. Minimum post-heat temperatures T_{H} may be at least 50° C., or at least 100° C., or at least 150° C., or at least 180° C. Post-heating may be achieved with the thermal spray applicator 12 and/or by an IR heater that is part of, or separate from, the thermal spray applicator 12.

When IR heaters are used for pre-heating and/or post-heating, any suitable conventional IR heater may be adapted for such use, such as infrared heat lamps, bulbs, wires and the like. The IR heater may operate at any desired wavelengths, for example, near-IR and/or mid-IR wavelengths. The IR heater may operate at any suitable power level, for example, a near-IR heat lamp may operate at a power level of from 2,000 watts or less to 3,000 watts or more, e.g., 2,500 watts.

Post-heat times may typically range from 1 second to 5 or 10 minutes or more, or from 10 to 360 seconds, or from 30 to 120 seconds, or from 45 to 90 seconds, or from 50 to 70 seconds, or from 30 to 60 seconds. Minimum post-heat times may be at least 1 second, or at least 10 seconds, or at least 30 seconds.

The post-heat temperatures T_{H} may be selected based upon the T_{g} of the coating. For example, T_{H} may be within the range T_{H}≥T_{g}+50° C., or +100° C., or +150° C., or +200° C.

The post-heat temperatures T_{H} may be selected based upon the melting point temperature (Tₘ) of the coating. For example, T_{H} may be T_{H}≥Tₘ+20° C., or +30° C., or +40° C. or +50° C., or +60° C.

During flight, the particle velocities of the heated coating particles 54 may be controlled to produce desired coating characteristics such as low surface roughness. The particle velocities may typically range from 5 to 50 m/s, for example, from 10 to 40 m/s, or from 15 to 30 m/s, or from 20 to 25 m/s. Minimum particle velocities may be at least 5 m/s, or at least 10 m/s, or at least 15 m/s, or at least 20 m/s, or at least 25 m/s, and may be adjusted to minimize surface roughness of the coatings. Maximum particle velocities may be less than 50 m/s, or less than 40 m/s, or less than 30 m/s.

The spray distance D may typically range from 0.01 to 2 meters, for example, from 0.05 to 1 meter, or from 0.1 to 0.8 meter, or from 0.15 to 0.5 meter, or from 0.3 to 0.45 meter. Minimum spray distances D may be at least 0.01 meter, or at least 0.05 meter, or at least 0.1 meter, or at least 0.15 meter, or at least 0.3 meter. Maximum spray distances D may be less than 2 meters, or less than 1 meter, or less than 0.8 meter, or less than 0.5 meter, or less than 0.45 meter.

Flight times may typically range from 0.001 to 0.1 second, for example, from 0.002 to 0.05 second, or from 0.005 to 0.02 second.

The thermal spray systems may apply coatings at relatively large deposition rates, for example, at least 100 ft²/hour, or at least 500 ft²/hour, or at least 1.000 ft²/hour.

The coating thickness T typically is less than 500 microns, for example, less than 200 microns, or less than 150 microns, or less than 125 microns, or less than 100 microns. The coating thickness may typically range from 5 to 500 microns, for example, from 10 to 200 microns, or from 50 to 125 microns, or from 75 to 100 microns.

The coatings may be relatively smooth, with surface roughnesses below selected roughness values, for example, as measured by three-dimensional roughness images and conventional software, as more fully described below. The roughness values, measured in microns, may typically be less than 15 microns, or less than 10 microns, or less than 5 microns, or less than 2 microns. Surface roughness may be decreased as a result of the pre-heating and/or post-heating, for example, by pre-heating the substrate to help the coating powders become tacky or sticky when they are initially deposited on the substrate, or by heating the substrate and deposited coating powders during spraying and post-heating to cause the coatings to flow out and cure after deposition.

Various types of thermoset and thermoplastic coatings may be produced with the present thermal spray systems, including primers, chemical agent resistant primer coatings, base coats, chemical agent resistant base coatings, final coats, chemical agent resistant top coatings, architectural coatings, automotive coatings, aerospace coatings, marine coatings, metal coatings, refinish coatings, fixture coatings, floor coatings, repair coatings, precision coatings, antimicrobial coatings, zinc oxide coatings, zinc rich coatings, protective coatings, corrosion resistant coatings, UV durable coatings, metallic effect coatings, clear coatings, high edge protective coatings, chip resistant coatings, high lubricity/high release coatings, easy to clean and non-stick coatings, mold release coatings, retro-reflective coatings, traffic marking coatings, and the like.

When the coatings are used as primer coatings, suitable compositions include zinc-containing epoxy, epoxy-polyester hybrid, polyvinylidene fluoride (PVDF), polyvinylidene fluoride (PVDF)-polyester, polyamide-imide (PAI) and the like. For example, when PAI is used as a primer coating, the PAI may be compatible as a primer, for example, with polyester and PVDF topcoats to provide good physical and chemical properties.

Examples of antimicrobial coatings include coatings containing antimicrobial metal particles such as Ag, Cu and the like. The antimicrobial metal particles may be dispersed directly in or on the thermally sprayed thermoset or thermoplastic coating layers or may be combined with other materials such as glass to form composite particles that are dispersed in or on the coating layers.

The following examples are for illustration purposes, which, however, are not to be considered as limiting.

### EXAMPLES

Samples of thermoset and thermoplastic coating powders were thermally sprayed. Sample 1 used an epoxy-polyester hybrid powder. Samples 2, 3 and 4 are low gloss PVDF/acrylic formulas. Sample 2 was a thermoplastic acrylic coating powder having a relatively high average molecular weight of 30,000. Sample 3 was a thermoplastic acrylic coating powder having an intermediate average molecular weight of 16.000. Sample 4 was a thermoplastic acrylic coating powder having a relatively low average molecular weight of 11,000. Each of the thermoset and thermoplastic coating powders had an average particle size of from 35 to 40 microns and particle size distributions of d90 of 100 and d10 of 10.

A commercially available thermal powder applicator sold under the designation of PTS-30 by Resodyn Engineered Polymeric Systems was adapted and used to thermally spray the selected powder samples under controlled parameters including preheat temperature, post heat temperature and particle velocity dictated by cooling air lever on applicator head. During each thermal spray process, the selected powder coating sample was loaded into a fluidized bed hopper of the applicator and thermally sprayed onto a steel panel located a distance of 18 inches from the applicator. The resultant coatings had thicknesses of from 75 to 100 microns. During spraying operations, the substrate was pre-heated using the thermal spray applicator to a temperature of either 170° C. or 200°. The coatings were sprayed at an average particle velocity of cither 20 m/s or 25 m/s as measured by Oxford Lasers Visisize. After each coating was applied to the substrate, a post-heat temperature of either 200° C. or 240° C. was applied by the thermal spray applicator to some of the deposited coatings for a time of about 60 seconds. Alternatively, some of the applied coatings were not subjected to a post-heat temperature.

Properties of the thermally sprayed coatings are measured by standard techniques including Oxford laser, Malvern laser and infrared imaging techniques. Results of the tests are listed below in Tables 1-4. Imaging and surface texture evaluations were completed with a Keyence Macroscope to generate roughness charts, as more fully described below. Texture or roughness data is represented as a surface averaged amplitude of the deviation of surface texture from a baseline surface in the units of microns. Three-dimensional roughness images were generated by Keyence VR3200 Macroscope used for roughness values and 3D images. Roughness values are reported in microns in this software.

TABLE 1
Coating Powder Sample No. 1 - Thermoset

| | | Particle | | |
|---|---|---|---|---|
| Pre-Heat | Post-Heat | Velocity | | Roughness |
| Temp (° C.) | Temp (° C.) | (m/s) | Magnification | (μm) |
| 170 | none | 20 | 40 | 2.57 |
| 170 | none | 20 | 120 | 2.37 |
| 170 | 200 | 20 | 40 | 3.24 |
| 170 | 200 | 20 | 120 | 2.61 |
| 170 | none | 25 | 40 | 1.92 |
| 170 | none | 25 | 120 | 1.83 |
| 170 | 200 | 25 | 40 | 2.21 |
| 170 | 200 | 25 | 120 | 2.18 |
| 170 | none | 20 | 40 | 3.81 |
| 170 | none | 20 | 120 | 2.9 |
| 170 | 240 | 20 | 40 | 3.52 |
| 170 | 240 | 20 | 120 | 2.51 |
| 170 | none | 25 | 40 | 2.07 |
| 170 | none | 25 | 120 | 1.97 |
| 170 | 240 | 25 | 40 | 1.99 |
| 170 | 240 | 25 | 120 | 2.5 |
| 200 | none | 20 | 40 | 5.42 |
| 200 | none | 20 | 120 | 5.32 |
| 200 | 200 | 20 | 40 | 5.82 |
| 200 | 200 | 20 | 120 | 5.87 |
| 200 | none | 25 | 40 | 3.56 |
| 200 | none | 25 | 120 | 3.43 |
| 200 | 200 | 25 | 40 | 4.2 |
| 200 | 200 | 25 | 120 | 3.99 |
| 200 | none | 20 | 40 | 4.3 |
| 200 | none | 20 | 120 | 3.92 |
| 200 | 240 | 20 | 40 | 4.48 |
| 200 | 240 | 20 | 120 | 4.47 |
| 200 | none | 25 | 40 | 4.12 |
| 200 | none | 25 | 120 | 4.13 |
| 200 | 240 | 25 | 40 | 2.98 |
| 200 | 240 | 25 | 120 | 3.12 |

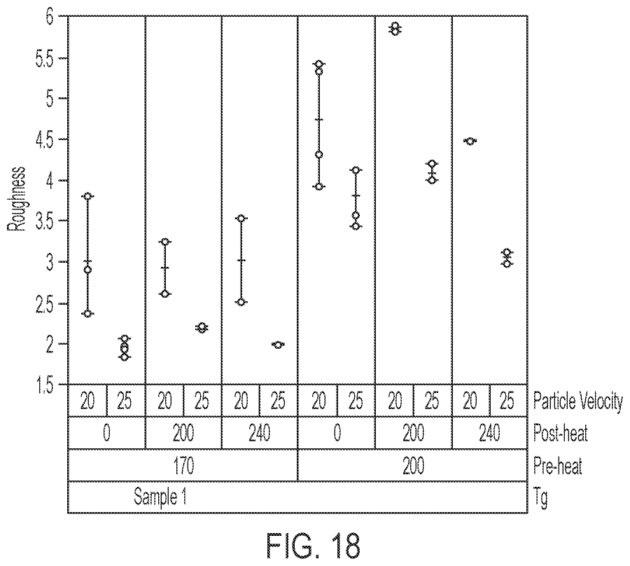

FIG. 18 is a roughness chart for thermally sprayed thermoset coatings subjected to different application parameters listed in Table 1.

TABLE 2
Coating Powder Sample No. 2 - High Mw Thermoplastic

| | | Particle | | |
|---|---|---|---|---|
| Pre-Heat | Post-Heat | Velocity | | Roughness |
| Temp (° C.) | Temp (° C.) | (m/s) | Magnification | (μm) |
| 170 | none | 20 | 40 | 17.52 |
| 170 | none | 20 | 120 | 15.93 |
| 170 | 200 | 20 | 40 | 15.65 |
| 170 | 200 | 20 | 120 | 16.64 |
| 170 | none | 25 | 40 | 25.07 |
| 170 | none | 25 | 120 | 23.75 |
| 170 | 200 | 25 | 40 | 14.42 |
| 170 | 200 | 25 | 120 | 14.3 |
| 170 | none | 20 | 40 | 26.42 |
| 170 | none | 20 | 120 | 29.15 |
| 170 | 240 | 20 | 40 | 15.9 |
| 170 | 240 | 20 | 120 | 16.85 |
| 170 | none | 25 | 40 | 22.36 |
| 170 | none | 25 | 120 | 21.36 |
| 170 | 240 | 25 | 40 | 13.7 |
| 170 | 240 | 25 | 120 | 13.49 |
| 200 | none | 20 | 40 | 16.39 |
| 200 | none | 20 | 120 | 18.61 |
| 200 | 200 | 20 | 40 | 16.56 |
| 200 | 200 | 20 | 120 | 18.54 |
| 200 | none | 25 | 40 | 17.72 |
| 200 | none | 25 | 120 | 17.6 |
| 200 | 200 | 25 | 40 | 15.99 |
| 200 | 200 | 25 | 120 | 17.42 |
| 200 | none | 20 | 40 | 20.16 |
| 200 | none | 20 | 120 | 21.76 |
| 200 | 240 | 20 | 40 | 17.13 |
| 200 | 240 | 20 | 120 | 17.39 |
| 200 | none | 25 | 40 | 19.58 |
| 200 | none | 25 | 120 | 20.58 |
| 200 | 240 | 25 | 40 | 17.06 |
| 200 | 240 | 25 | 120 | 17.78 |

TABLE 3
Coating Powder Sample No. 3 - Middle Mw Thermoplastic

| | | Particle | | |
|---|---|---|---|---|
| Pre-Heat | Post-Heat | Velocity | | Roughness |
| Temp (° C.) | Temp (° C.) | (m/s) | Magnification | (μm) |
| 170 | none | 20 | 40 | 14.95 |
| 170 | none | 20 | 120 | 15.04 |
| 170 | 200 | 20 | 40 | 20.2 |
| 170 | 200 | 20 | 120 | 20.14 |
| 170 | none | 25 | 40 | 17.53 |
| 170 | none | 25 | 120 | 17.32 |
| 170 | 200 | 25 | 40 | 13.66 |
| 170 | 200 | 25 | 120 | 14.34 |
| 170 | none | 20 | 40 | 18.1 |
| 170 | none | 20 | 120 | 20.11 |
| 170 | 240 | 20 | 40 | 14.58 |
| 170 | 240 | 20 | 120 | 16.04 |
| 170 | none | 25 | 40 | 13.6 |
| 170 | none | 25 | 120 | 15.24 |
| 170 | 240 | 25 | 40 | 12.98 |
| 170 | 240 | 25 | 120 | 12.78 |

TABLE 4
Coating Powder Sample No. 4 - Low Mw Thermoplastic

| | | Particle | | |
|---|---|---|---|---|
| Pre-Heat | Post-Heat | Velocity | | Roughness |
| Temp (° C.) | Temp (° C.) | (m/s) | Magnification | (μm) |
| 170 | none | 20 | 40 | 15.35 |
| 170 | none | 20 | 120 | 16.25 |
| 170 | 200 | 20 | 40 | 9.39 |
| 170 | 200 | 20 | 120 | 8.5 |
| 170 | none | 25 | 40 | 11.93 |
| 170 | none | 25 | 120 | 12.42 |
| 170 | 200 | 25 | 40 | 7.42 |
| 170 | 200 | 25 | 120 | 7.23 |
| 170 | none | 20 | 40 | 15.97 |
| 170 | none | 20 | 120 | 16.58 |
| 170 | 240 | 20 | 40 | 7.83 |
| 170 | 240 | 20 | 120 | 7.93 |
| 170 | none | 25 | 40 | 11.05 |
| 170 | none | 25 | 120 | 11.24 |
| 170 | 240 | 25 | 40 | 6.92 |
| 170 | 240 | 25 | 120 | 6.9 |
| 200 | none | 20 | 40 | 11.02 |
| 200 | none | 20 | 120 | 10.45 |
| 200 | 200 | 20 | 40 | 8.67 |
| 200 | 200 | 20 | 120 | 8.07 |
| 200 | none | 25 | 40 | 8.06 |
| 200 | none | 25 | 120 | 8.09 |
| 200 | 200 | 25 | 40 | 7.07 |
| 200 | 200 | 25 | 120 | 7.32 |
| 200 | none | 20 | 40 | 10.27 |
| 200 | none | 20 | 120 | 10.56 |
| 200 | 240 | 20 | 40 | 7.43 |
| 200 | 240 | 20 | 120 | 7.51 |
| 200 | none | 25 | 40 | 11.9 |
| 200 | none | 25 | 120 | 12.14 |
| 200 | 240 | 25 | 40 | 6.66 |
| 200 | 240 | 25 | 120 | 6.43 |

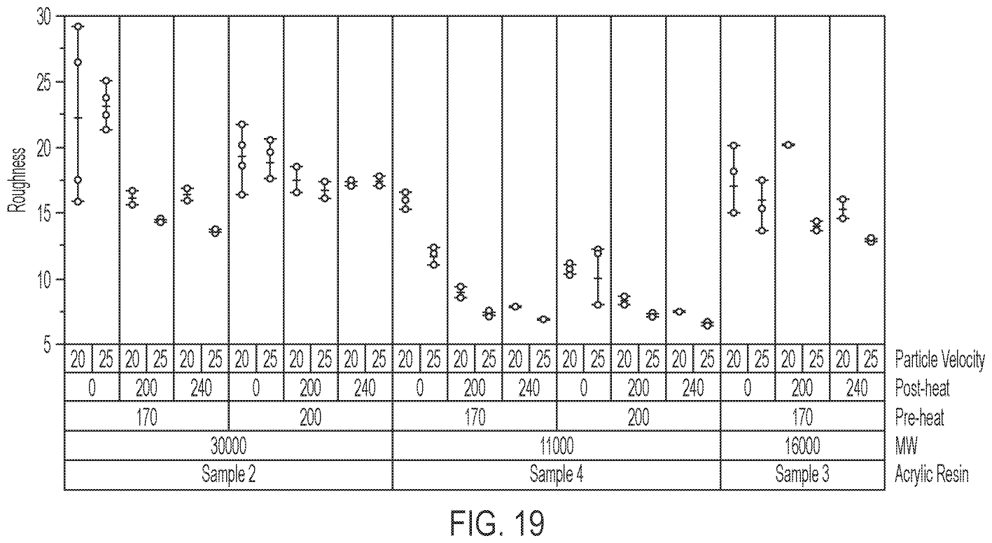

FIG. 19 shows a roughness chart for thermally sprayed thermoplastic coatings subjected to different application parameters listed in Tables 2-4.

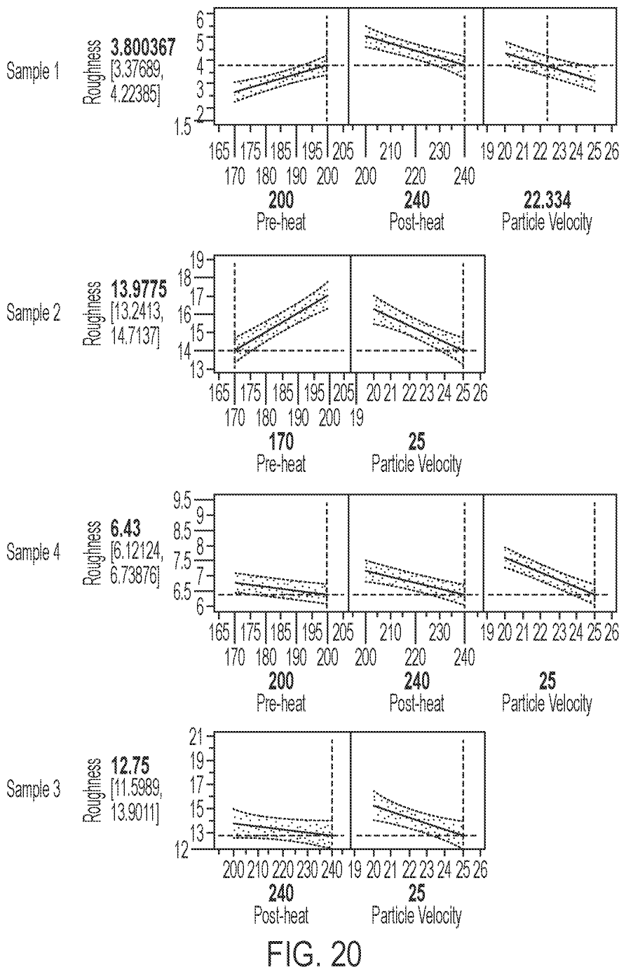

FIG. 20 includes roughness charts vs. application parameters of preheat temperature, post heat temperature, and particle velocity. FIG. 20 details roughness measurements captured using the Keyence Macroscope (3d Imaging and internal software calculates Sa, which is roughness metric). The charts indicate that higher particle velocity, as dictated by cooling air setting, causes lower roughness values.

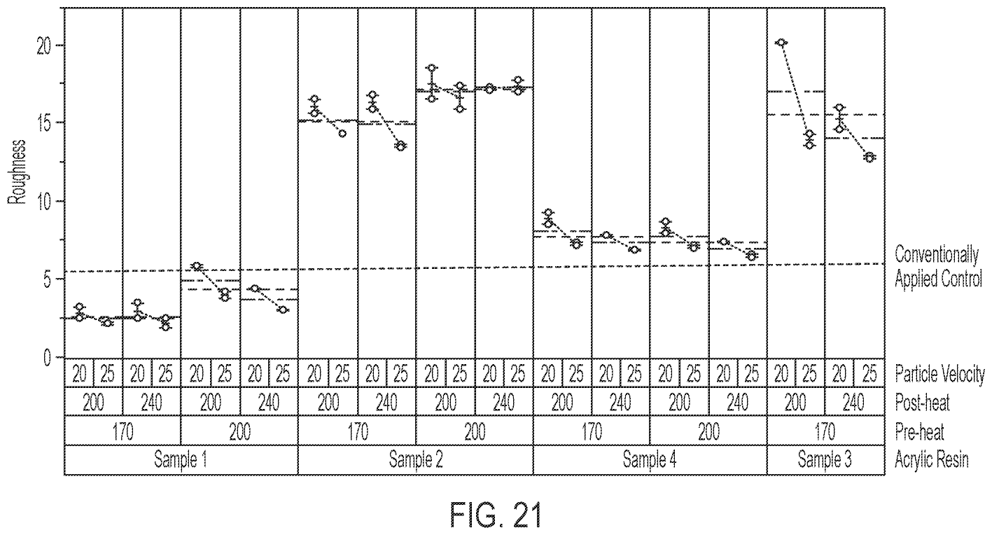

FIG. 21 includes roughness charts for thermally sprayed coatings corresponding to samples 1-4. The dotted line indicates the roughness value of an electrostatically applied control coating. FIG. 21 details roughness values for a series of coatings applied with thermal applicator at various settings for particle velocity, pre-heat and post-heat temperature. The figure provides further evidence that increased particle velocity contributes to smoother films across the tested chemistries. The figure also shows that roughness is largely chemistry dependent.

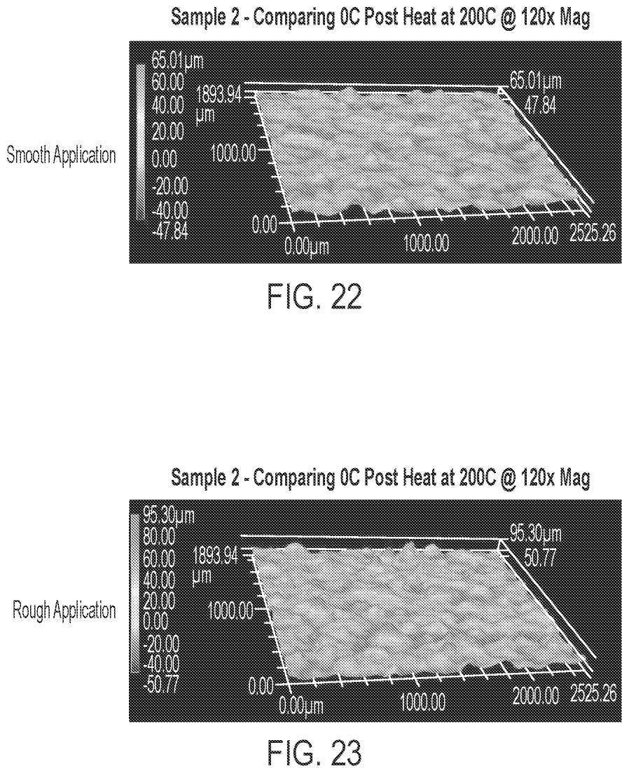

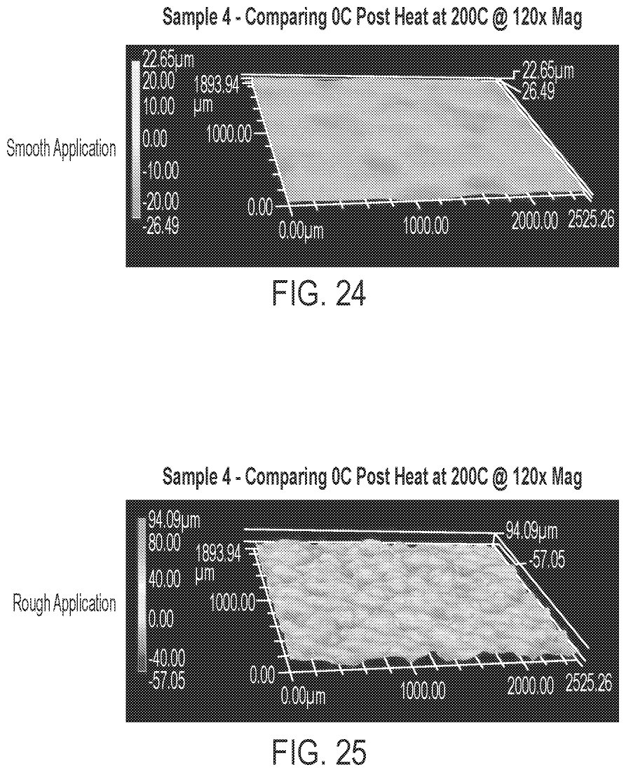

FIGS. 22 and 23 are three-dimensional surface images of two different coatings produced in accordance with parameters listed in Table 2. FIGS. 24 and 25 are three-dimensional surface images of two different coatings produced in accordance with parameters listed in Table 4. Both sets of images show application at different particle velocity settings. Smooth application corresponds to 25 m/s, rough application corresponds to 20 m/s. Smoother application is better and needed for proper substrate coverage and avoiding issues with potential corrosion and other film property deterioration. The higher particle velocity thus contributes to better overall film application.

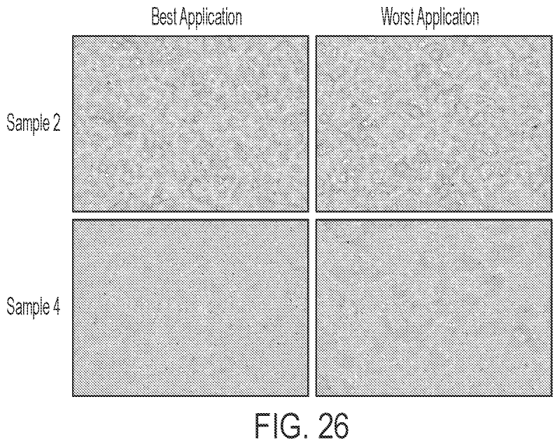

FIG. 26 shows 120× magnification images that correspond to the images in FIGS. 22-25. “Best Application” corresponds to smooth applications and “Worst Application” corresponds to rough applications.

The present disclosure utilizes the melting of powders in flight instead of applying a charge to the particle. Electrostatic powder deposition is not required, and a large range of substrates powder technologies may be utilized. The powder coatings may have higher physical strength, chemical resistance, weather and corrosion performance and lower environmental impact than conventional liquid coatings.

For purposes of the detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth broad scope are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, unless indicated otherwise, a plural term can encompass its singular counterpart and vice versa, unless indicated otherwise. In addition, in this application, the use of “or” means “and/or” unless specifically stated otherwise, even though “and/or” may be explicitly used in certain instances.

As used herein, “including.” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect basic and novel characteristic(s)”.

As used herein, the terms “on,” “onto,” “applied on,” “applied onto,” “formed on,” “deposited on,” “deposited onto,” mean formed, overlaid, deposited, or provided on but not necessarily in contact with the surface. For example, an electrodepositable coating composition “deposited onto” a substrate does not preclude the presence of one or more other intervening coating layers of the same or different composition located between the electrodepositable coating composition and the substrate.

Whereas specific details have been described, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure, which is to be given the full breadth of the claims appended and any and all equivalents thereof.

1. A method of thermal spraying a polymeric coating comprising:
heating particles of a powder polymeric coating material with a thermal spray applicator and directing the heated coating particles toward a substrate;
depositing the heated coating particles on the substrate to form a deposited coating; and
post-heating the deposited coating on the substrate to form the polymeric coating.

2. The method of claim 1, wherein the post-heating produces a post-heat treatment temperature of the deposited coating of at least 50° C.

3.-4. (canceled)

5. The method of claim 1, wherein the post-heating is applied to the deposited coating on the substrate for at least 10 seconds.

6. (canceled)

7. The method of claim 1, wherein the post-heating is performed by the thermal spray applicator or by an IR heater.

8. (canceled)

9. The method of claim 1, further comprising pre-heating the substrate prior to the deposition of the heated particles on the substrate.

10. The method of claim 9, wherein the pre-heating is performed by the thermal spray applicator or by an IR heater.

11. (canceled)

12. The method of claim 9, wherein the pre-heating produces a pre-heat treatment temperature of the substrate of at least 100° C.

13.-15. (canceled)

16. The method of claim 1, wherein the heated coating particles are directed toward the substate with a particle velocity of at least 20 meters/second.

17.-18. (canceled)

19. The method of claim 1, wherein the coating particles have an average particle size of less than 50 microns.

20.-22. (canceled)

23. The method of claim 1, wherein the polymeric coating material comprises at least one thermoset polymer comprising polyester, acrylic, non-BPA epoxy, polyamide, polyurethane, polyurea, BPA epoxy, polyimide, fluoropolymer, polysiloxane, polysulfone, polysulfide, polyolefin, polyether, polyketone and/or polyvinyl polymers.

24. (canceled)

25. The method of claim 1, wherein the polymeric coating material comprises at least one thermoplastic polymer comprising fluoropolymers, FEVE, PTFE, PVC, polyolefin, polyamide, PVDF, polysiloxane, polyketone, polyester, polyurethane, polyurea, polysulfone vinyl acetate polymers, acrylic polymers and/or acrylic/vinyl acetate copolymers.

26. (canceled)

27. The method of claim 1, wherein the polymeric coating material comprises a primer composition comprising zinc-containing epoxy, epoxy-polyester hybrid, polyvinylidene fluoride (PVDF), polyvinylidene fluoride (PVDF)-polyester and/or polyamide-imide (PAI).

28. (canceled)

29. The method of claim 1, wherein the polymeric coating material has a molecular weight of from 5,000 to 100,000.

30.-31. (canceled)

32. The method of claim 1, wherein the polymeric coating material has a glass transition temperature of less than 120° C.

33. (canceled)

34. The method of claim 1, wherein the polymeric coating has a roughness of 15 microns or less.

35. The method of claim 1, wherein the polymeric coating has a thickness of less than 500 microns.

36.-38. (canceled)

39. The method of claim 1, wherein the spray coating pattern is non-circular or non-uniform.

40. The method of claim 1, wherein the spray coating pattern is applied to the substrate in multiple overlapping passes.

41. (canceled)

42. A thermal spray applicator for thermal spraying of coatings comprising:
a combustion chamber including a combustion zone structured and arranged to receive a fuel/air mixture; and
an injection nozzle assembly structured and arranged to receive heat flow from the combustion chamber, the injection nozzle assembly comprising:
a coating powder injector nozzle including a coating powder nozzle inlet adjacent a base of the coating powder injector nozzle, and a coating powder nozzle outlet at a nozzle front opening of the coating powder injector nozzle; and
an air shroud at least partially surrounding the coating powder injector nozzle defining a shroud air flow region between the coating powder injector nozzle and the air shroud, wherein
the coating powder injector nozzle is structured and arranged to produce a non-circular or non-uniform spray coating pattern when the coating powder passes through the coating powder nozzle outlet and is subjected to shroud air flowing out from the shroud air flow region and the heat flow from the combustion chamber.

43. (canceled)

44. The thermal spray applicator for thermal spraying of coatings of claim 42, comprising a flow diverter located at least partially downstream from the nozzle front opening structured and arranged to affect a flow pattern of the coating powder.

45.-49. (canceled)
